(19) United States
(12) Patent Application Publication
(10) Pub. No.: US 2024/0258970 A1
(43) Pub. Date: Aug. 1, 2024

(54) ELECTRONIC CIRCUIT FOR A PHOTOVOLTAIC MODULE AND METHOD FOR SWITCHING IN A PHOTOVOLTAIC MODULE

(71) Applicant: Fraunhofer-Gesellschaft zur Förderung der angewandten Forschung e.V., München (DE)

(72) Inventors: Stefan REICHERT, Freiburg (DE); Jörg BORNWASSER, Freiburg (DE); Heribert SCHMIDT, Freiburg (DE)

(21) Appl. No.: 18/630,104

(22) Filed: Apr. 9, 2024

Related U.S. Application Data
(63) Continuation of application No. PCT/EP2022/077954, filed on Oct. 7, 2022.

(30) Foreign Application Priority Data
Oct. 11, 2021 (DE) 10 2021 211 448.2

(51) Int. Cl. H02S 50/10; H02H 3/38; H02H 7/20; H02J 3/38; H02S 40/34

(52) U.S. Cl. CPC H02S 50/10; H02H 3/38; H02H 7/20; H02J 3/381; H02S 40/34; H02J 2300/26; H02J 2310/48

(57) ABSTRACT

An electronic circuit for a PV module includes PV terminals for coupling to a PV module, and string terminals for coupling to a PV string. A current path runs between the PV terminals and the string terminals, configured to conduct an electric current from the PV module in a first current flow direction to the PV string. The electronic circuit includes a disconnector arranged between a first terminal of the PV terminals and a second terminal of the string terminals, configured to interrupt the current path, in a first state, along the first current path direction and to close the current path, in a second state, along the first current flow direction. The electronic circuit includes a controller, configured to obtain current flow information about a current flow in at least one sub-portion of the current path along a second current flow direction opposite to the first current flow direction.

### CROSS-REFERENCES TO RELATED APPLICATIONS

This application is a continuation of copending International Application No. PCT/EP2022/077954, filed Oct. 7, 2022, and additionally claims priority from German Application No. 10 2021 211 448.2, filed Oct. 11, 2021, which are both incorporated herein by reference in their entirety.

### BACKGROUND OF THE INVENTION

The present invention relates to an electronic circuit for a photovoltaic module, a photovoltaic system, to a vehicle with a photovoltaic system, and to a method for switching a photovoltaic module into a photovoltaic string. The present invention further relates to an intelligent circuit for electric car for disconnecting an in-vehicle photovoltaic (PV) high-voltage string.

The field of in-vehicle photovoltaics (or Vehicle Integrated Photovoltaics, VIPV) is characterized by being highly dynamic. A variety of manufacturers offers solutions nowadays. In this regard, a distinction can be made between the areas of passenger cars and utility vehicles. Due to the limited surfaces on a passenger car and the applicable safety regulations, solutions with a maximum photovoltaic (PV) voltage of <60 V (safety extra-low voltage) have become prevalent. Keeping to the maximum voltage is achieved by the PV modules, or PV strings, being connected in parallel, or a separate DC/DC converter input being used for each module. In the field of utility vehicles, larger installable PV powers can be realized due to the large usable roof surface. Even in the case of smaller trucks, a power in a single-digit kW range can be assumed. In order to minimize the wiring effort and cable cross-section, it may be advisable to connect the PV modules in series and thus keep the PV current low. In this case, however, the PV voltage exceeds the safety extra-low voltage.

During normal operation of the PV modules, the DC/DC converter, and the high-voltage (HV) circuit, and the HV battery of a PV installation, the insulation is monitored by an IMD (insulation monitoring device). However, if the HV circuit is disconnected, e.g. in the case of an accident, and thus, the battery is removed, the IMD does not assume a protective function of the PV side. The potentially dangerous voltage of the PV modules connected in series (open-circuit voltage) continues to be applied in the entire PV circuit. Even during the disconnection of the so-called Service Disconnect Box, an undesirably high voltage is applied in the PV circuit.

In order to avoid the problem of a high voltage in the area of vehicle integrated photovoltaics, up to now, a series connection of the PV modules and PV strings has been forgone, or series connections are only implemented within the context of safety extra-low voltages. In the field of stationary photovoltaics, solutions exist which utilize a communication channel between a central DC/DC converter or inverter and the individual PV modules via Power Line Communication (PLC).

Concepts for switching PV modules into a PV string simply and safely are desirable.

### SUMMARY

According to an embodiment, an electronic circuit for a photovoltaic, PV, module may have: PV terminals for coupling to the PV module; and string terminals for coupling to a PV string; a current path running between the PV terminals and the string terminals, which current path is configured to conduct an electric current generated in the PV module in a first current flow direction to the PV string; a disconnector arranged between a first terminal of the PV terminals and a second terminal of the string terminal, which disconnector is configured to interrupt the current path in a first state along the first current flow direction; and to close the current path in a second state along the first current flow direction; a controller, which is configured to acquire current flow information about a current flow in at least one sub-portion of the current path along a second current flow direction opposite to the first current flow direction; and to control the disconnector from the first state into the second state based on the current flow information.

According to another embodiment, a photovoltaic assembly may have: a PV module; and an inventive electronic circuit coupled to the PV module as mentioned above.

According to yet another embodiment, a PV system may have: a plurality of inventive PV assemblies as mentioned above, serially connected in a PV string; an electric voltage converter coupled to the PV string, which is configured to acquire and convert an electric voltage based on the current flow in the first current flow direction; and a source for applying the current flow in the second current flow direction; wherein the voltage converter is configured to control the source to switch at least one PV assembly into the PV string.

According to yet another embodiment, a vehicle may have an inventive PV system as mentioned above.

According to yet another embodiment, a method may have the steps of: providing an electronic circuit with a control current directed opposite to the first current direction; wherein the electronic circuit is coupled between the PV module and the PV string and is present in a first state, in which a disconnector disconnects a current path running across the PV module, and in which a current of the PV module delivered in a first current direction to the PV string is prevented; controlling the disconnector into a second state, in which the current flow along the first current direction is enabled to close the current path based on the control current.

A core idea of the present invention is to have found that a reversal of a current flow direction in the PV string can be used as an information basis or carrier to excite a decentralized electronic circuit to re-connect the PV module, which is managed by or connected to the circuit, to the PV string. This allows a decentralized decision to be made about the removal of the PV module from the PV string in order to meet safety regulations, particularly regarding the safety extra-low voltage, in case of unforeseen and/or foreseen events, such as an accident or the like. This allows implementing a series connection of PV modules that allows high voltages during normal operation, but reduces the respective voltage as needed, thus offering a high degree of safety. The switching-in by means of the altered current direction checks, on the one hand, whether the PV string is intact, and furthermore allows foregoing a separate communication channel, so that switching the respective PV module into the string is possible with minimal risk and simultaneously low complexity.

According to an embodiment, an electronic circuit for a PV module includes PV terminals coupling to the PV module, and string terminals for coupling to a PV string. A current path runs between the PV terminals and the string terminals, which current path is configured to conduct an electric current generated in the PV module in a first current flow direction to the PV string. A disconnector is arranged between at least one of the PV terminals and at least one of the string terminals, which disconnector is configured to interrupt the current path in a first state along the first current flow direction, and to close the current path in a second state along the first current flow direction. The electronic circuit comprises a controller configured to obtain current flow information about a current flow in at least one sub-portion of the current path along a second current flow direction opposite the first current flow direction, and to control the disconnector from the first state into the second state based on the current flow information.

According to an embodiment, the disconnector is designed such that it includes a semiconductor switch with a switchable current path and a body diode acting in parallel with the switchable current path. The disconnector is configured to conduct, in the first state of the disconnector, the current flow via the body diode along the second current flow direction. This allows for a simple yet reliable implementation for determining the current flow into the second current flow direction. A current flow through the switch part of the semiconductor switch may be prevented due to its control, while the body diode, which is conductive along the second current flow direction, is correspondingly functional.

According to an embodiment, the disconnector includes at least a first and a second semiconductor switch, which are connected to one another in series or in parallel, which does not exclude additional semiconductor switches. The serially connected semiconductor switches include body diodes functioning along the second current flow direction, i.e. conductive body diodes. A parallel connection of such switches may also be designed accordingly. The advantage of this is that these body diodes can be used with no relevant additional effort while the semiconductor switches can be switches quickly and reliably.

According to an embodiment, the electronic circuit includes a sensor means configured to recognize a current flow along the second current flow direction, wherein the current flow information is based on the recognized current flow. The advantage of this is that the current flow is recognizable with simple means.

According to an embodiment, the sensor means is configured to detect a voltage drop via a body diode of a semiconductor switch of the disconnector, wherein the voltage drop is causally related to the current flow. The advantage of this is that a voltage is recognizable with simple means. Even if a current strength can be evaluated, embodiments may recognize the current flow along the second direction even from the presence of the voltage drop via the at least one body diode, so that the electronic circuit can use this information for switching in the PV module.

According to an embodiment, the electronic circuit includes a bypass diode, which is coupled between the string terminals and which is configured to enable, in the first state, an electric current flow in the string. This means that in the first state, the current of the string can be conducted over the bypass diode. The current directed in the opposite direction along the second current flow direction is not conducted by the bypass diode or is suppressed by it, so that the current flow, e.g. via the body diodes, is easily recognizable along the second current flow direction.

According to an embodiment, the controller is configured to control the disconnector from the second state into the first state based on a switch-off event. A switch-off event may be, e.g. an open circuit, a shadowing and/or a string short circuit. According to a possible implementation of this, the controller may be configured to recognize the switch-off event as a switch-off event caused in the PV module, or the string, or the electronic circuit, i.e. a decentralized switch-off event. A decentralized switching off is possible without problems as, due to the current flow along the second current flow direction, a centrally initiated switching-in can be triggered at least temporarily.

According to an embodiment, the controller is configured to control the disconnector into the second state, after the recognized switch-off event, i.e. after a completed disconnection, depending on the current flow, obtained via the string, along the second current flow direction. This makes it possible to transition back into the second state, at least tentatively, whereby the controller is able to check whether the switch-off event is still present or is remedied, for example after a permanent shadowing.

According to an embodiment, the controller is configured to temporarily switch the disconnector into the first state upon a temporary power setback of the PV module, such as a longer shadowing situation, and to control into the second state independently of the current flow, obtained by the string, along the second current flow direction, for example to check whether a temporary power setback causing the switch-off has ended. This means that the impulse to change into the second state, which impulse is obtained via the string and indicated by means of the current flow along the second direction, does not need to be the only option to change into the second state. Rather, a decentralized decision may also be made to change or return into this state at least temporarily, which also offers advantages in the case of short shadowings.

According to an embodiment, the electronic circuit is configured without a communication interface, which means that the change between the operating states may take place, in a broader sense, without communication or without explicit communication, for example by interpreting the current flow along the second current flow direction without messages of a communication protocol having to be transmitted for that purpose, which allows for a simple controlling of the PV installation.

According to an embodiment, the electronic circuit is configured to perform, in the second state of the disconnector, at least one of
a) Maximum Power Point Tracking (MPPT) for the PV module,
b) disconnecting the PV module from the string upon recognition of a short circuit,
c) disconnecting the PV module from the string upon recognition of an open circuit of the PV module, and
d) disconnecting the PV module from the string upon recognition of the PV module being shadowed and/or reconnecting of the PV module upon recognition of an end of the shadowing,
   i.e., perform one or more of these functions. This allows for the implementation of additional functionalities in the electronic circuit, which allows foregoing additional components and thereby providing an advantage.

According to an embodiment, the photovoltaic assembly includes a PV module and an electronic circuit described herein, which is coupled to the PV module.

According to an embodiment, a PV system includes a plurality of PV assemblies, which are serially connected in a string, according to embodiments described herein. In such PV systems, it is made possible to utilize high PV voltages and to simultaneously avoid them when a safe state of the PV installation or the PV system is needed by the respective PV module being disconnected from the string.

According to an embodiment, an electric voltage converter coupled to the string is provided for this purpose, which voltage converter is configured to obtain an electric circuit based on the current flow in the first current flow direction, and to convert the same. Furthermore, a source for applying a current flow in the second current flow direction is provided in the PV system. The voltage converter is configured to control the source to switch at least one PV assembly into the string. This means that, starting from the control of the source by the voltage converter, the PV assembly can be made to have the electronic circuit arranged therein couple the PV module to the string again.

According to an embodiment, the voltage converter includes the source or provides a function of the source. This may take place, e.g. by a variation of the input-side voltage on the voltage converter, which at least for a short time leads to a reversal of the current flow direction in the string in order to thus provide the current flow along the second current flow direction. This function can be implemented with simple means while allowing for a reliable control of the PV system.

According to an embodiment, the source is configured to provide the current along the second current flow direction as a direct current. The advantage of this is that a complex modulation and/or generation or conversion of an AC voltage or an alternating current can be done without.

According to an embodiment, the source comprises a current limitation and/or is configured to provide a constant current. The advantage of this is that the source does not need to know the string circuit in the PV system or the currently necessary voltage since it can adjust itself due to the constant current.

According to an embodiment, a vehicle includes a PV system described herein. Such a vehicle may be, for example, a passenger car or any other vehicle, although it advantageously is a truck, which may provide a large surface for PV modules.

According to an embodiment, a method for switching a PV module into a PV string includes providing an electronic circuit with a control current directed opposite to the first current direction. The electronic circuit is coupled between the PV module and the PV string and is present in a first operating state, in which a disconnector disconnects a current path running via the PV module, and in which a current of the PV module supplied to the string in a first current direction is prevented. The method further includes controlling the disconnector, based on the control current, into a second state, in which the current flow along the first current direction is made possible in order to close the current path.

### BRIEF DESCRIPTION OF THE DRAWINGS

Embodiments of the present invention will be detailed subsequently referring to the appended drawings, in which:

FIG. 1 shows a schematic block circuit diagram of an electronic circuit according to an embodiment;

FIG. 2 shows a schematic block circuit diagram of a PV assembly according to an embodiment;

FIG. 3 shows a schematic block circuit diagram of a PV system according to an embodiment;

FIG. 4 shows a U-I graph of a PV module upon being switched in according to an embodiment;

FIG. 5 shows a U-I graph of a PV module according to embodiments during a MPP tracking;

FIG. 6 shows a U-I graph for illustrating a switch-off caused by a short circuit and open circuit according to an embodiment;

FIG. 7 shows an exemplary tabular representation of different states of an electronic circuit according to an embodiment;

FIG. 8 shows a schematic side sectional representation of a vehicle according to an embodiment; and

FIG. 9 shows a schematic flow chart of a method according to an embodiment.

### DETAILED DESCRIPTION OF THE INVENTION

Before embodiments of the present invention are explained in more detail with reference to the drawings in the following, it is pointed out that identical, functionally equivalent or similarly acting elements, objects and/or structures are provided with equal reference numbers in the different figures, so that the description of said elements represented in different embodiments is interchangeable or can be applied to one another.

Embodiments described in the following are described in connection with a variety of details. Embodiments may, however, also be implemented without these detailed features. Furthermore, embodiments are described using block circuit diagrams instead of detailed representations for the sake of clarity. Moreover, details and/or features of individual embodiments may easily be combined with one another, provided that the description does not explicitly contradict this.

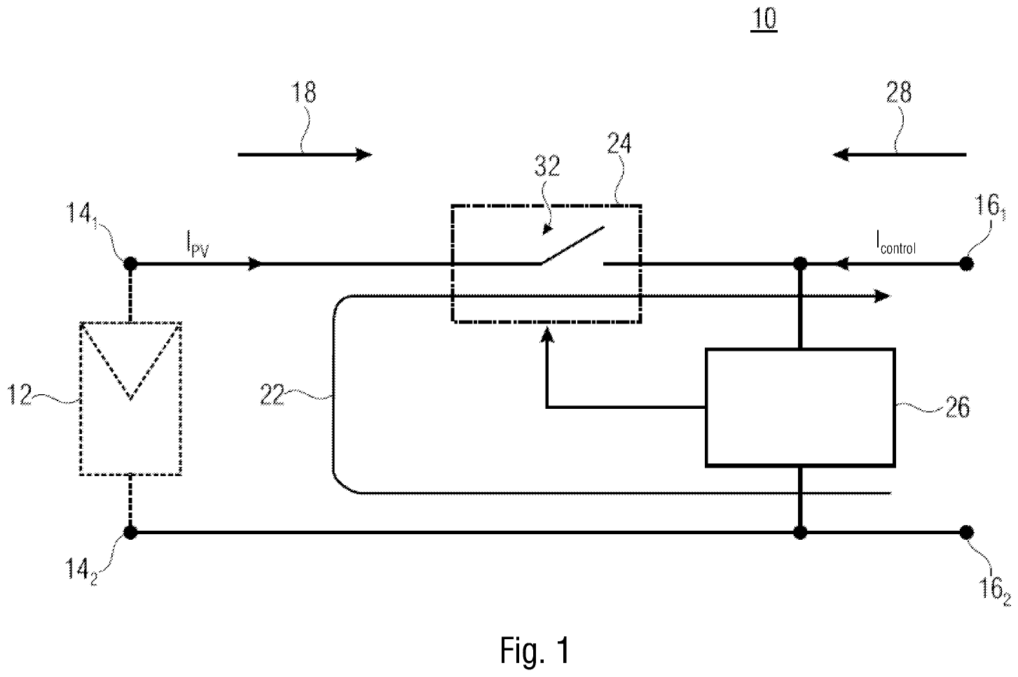

FIG. 1 shows a schematic block circuit diagram of an electronic circuit 10 according to an embodiment. The electronic circuit is advantageously configured for a photovoltaic (PV module 12, which may, but does not need to, be part of the electronic circuit 10.

The electronic circuit 10 includes PV terminals 14₁ and 14₂, which are configured for coupling to the PV module 12, wherein the number of the PV terminals 14₁ and 14₂ may be adapted to the design of the PV module 12 and may include a number of at least 1, at least 2, at least 3, at least 4, or more terminals. The voltage U_{PV_in} advantageously falls within the range of safety extra-low voltage and amounts to, e.g., a maximum of or less than 48 Volt, or a maximum of or less than 60 Volt, so that one or multiple PV modules 12 may also be coupled to one another.

The electronic circuit 10 further includes string terminals 16₁ and 16₂ in a number of advantageously at least 2, which are configured to be connected in a PV string in combination with one or multiple electronic circuits or PV assemblies. For example, a series connection of multiple PV assemblies may be provided in the PV string.

A current I_{PV}, which is supplied by the PV module 12, may be conducted, along a first current flow direction, through a current path 22 along the first current flow direction 18. The first current flow direction 18 may at least partially result from the design of the PV module 12, for example regarding a positive pole and/or a negative pole, as well as a polarity of the PV module 12 with respect to the circuit. In the current path 22, i.e., between at least one of the PV terminals 14₁, 14₂ and at least one of the string terminals 16₁, 16₂, a disconnector 24 is arranged, which is configured to interrupt, in a first state, the current path 22 along the first current flow direction 18, and to close, in a second state, the current path along the first current flow direction 18. The disconnector may, e.g., comprise at least one switch, a switch arrangement, and/or additional elements, if applicable. Semiconductor switches with body diodes, which allow a current conductivity opposite to the first current flow direction 18, are particularly advantageous.

The disconnector may be arranged, as shown, in the positive path, or at least partially in the negative path. The controller (26) may also be arranged, as an alternative to the arrangement shown, at least partially on the PV module side to utilize the electric power generated there as an energy supply.

The electronic circuit 10 includes a controller 26, which is configured to obtain a current flow information about a current flow or a current flow direction in at least a sub-portion of the current path 22 along a second current flow direction 28 opposite to the first current flow direction 18. Based on the current flow information, i.e., a current I_{control} flows along the second current flow direction 28 through at least the sub-portion of the current path 22, the controller 26 is configured to control the disconnector 24 from the first state to the second state, i.e., to switch the PV module 12 into the string, e.g., by a switch 32 of the disconnector arrangement 24 being controlled into a conducting state. The first current flow direction 18 can thus be oriented from the PV module towards the string, while the second current flow direction may run from the string towards the PV module and, e.g., via the body diodes. The switch 32 may be formed, e.g., differently from this as a semiconductor switch, for example as a mechanical switch or the like. A semiconductor switch may be formed, e.g., as a MOSFET or as an IGBT.

The current I_{control} may flow, for example, via the controller 25 and/or via accordingly configured elements of the disconnector 24. A current flowing via the disconnector 24 along the second current flow direction 28 may also be determined by the controller 26 without the controller 26 having to be part of the current path 22.

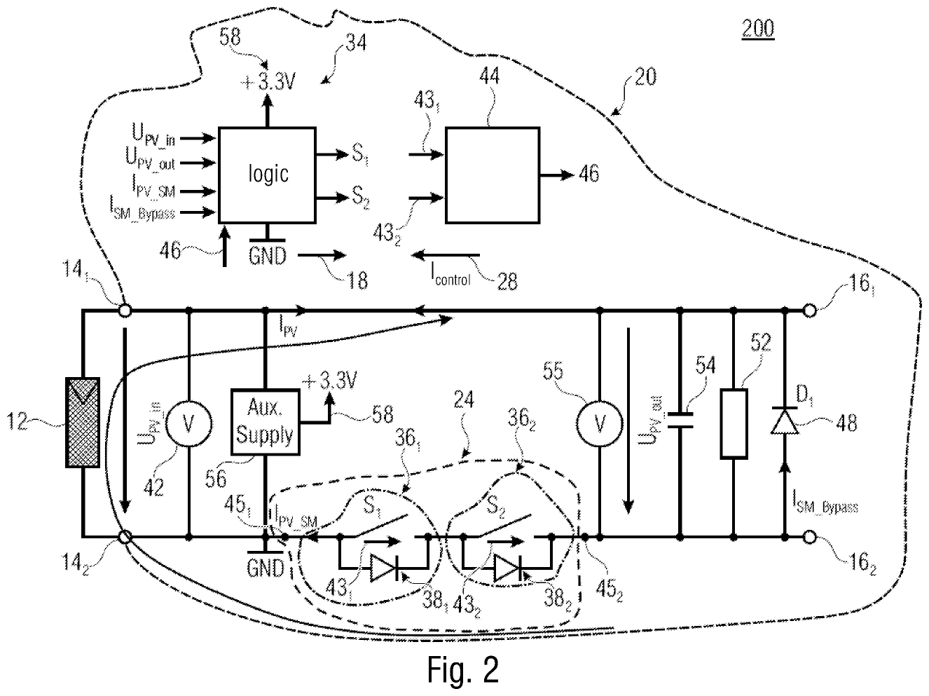

FIG. 2 shows a schematic block circuit diagram of a PV assembly 200 according to an embodiment. The PV assembly includes the PV module 12 and an electronic circuit 20 coupled to the PV module 12, wherein the electronic circuit 10 may also easily be provided as an alternative or in addition to the electronic circuit 20.

In this regard, the electronic circuit 20 includes a controller 34 that may comprise the functions of the controller 26. The controller 34 may comprise information about a series of voltages and/or currents in the electronic circuit 20 and control the disconnector 24 based thereon. In the embodiment shown, the disconnector 24 exemplarily includes two semiconductor switches 36₁ and 36₂ connected in series, which are designated as S₁ and S₂ and the body diodes 38₁ and 38₂ of which are rectified, which means that they have a conductive effect along the second current flow direction 28. However, it should be noted that any other number of switches, i.e., at least one, at least two, at least three, or more switches may also be connected in series and/or in parallel in the disconnector 24.

Alternatively or additionally, the use of semiconductor switches may be a possible design, but other types of switching elements may also be used as switches 32 of the disconnector 24, for example, mechanical switches or relays, to interrupt the current path 22 in the first state. The arrangement of multiple elements connected in series and/or in parallel allows for a high failure safety and/or a high degree of flexibility regarding the choice of components. For example, a permanently conducting first switch may, in a failure state, be compensated by a second switch serially connected thereto, which can still be brought into an opened state.

The control current I_{control} may flow via the body diodes 38₁ and 38₂ along the current flow direction 28, even when the switches 36₁ and 36₂ are opened or non-conducting. With these body diodes 38₁ and 38₂, a current path occurs that is different compared to the switches when it is compared to the current path 22 and, for example, a mechanical switch in cooperation with a separately connected diode is viewed. In case of using a semiconductor switch as the switch 36₁ and/or 36₂, the current path 22 may, in this regard, also be utilized completely by the control current I_{control}. An implementation of the switch 32 as at least one MOSFET semiconductor switch, or the use of multiple switches, of which at least one is formed as a MOSFET, may enable a synergetic use of an intrinsic body diode 38₁ and/or 38₂, which, however, does not exclude bringing additional diodes into circuit. If the disconnector 24 includes, e.g., a type of semiconductor switch, such as an IGBT, an effect comparable with that of the body diode 38₁ and/or 38₂ may be obtained by bringing an additional diode into circuit by connecting the same in parallel or anti-parallel. Such a connection of a diode may also be realized when using a mechanical switch or a relay. It should be noted that the disconnector 24 may comprise one or multiple switching elements of the same type or of different types.

Optionally, one or multiple of the following information sources may be arranged in the electronic circuit 20 for supplying the controller 34 with additional information. Thus, for example, a sensor means 42 may be provided, which detects an electric voltage U_{PV_in} provided by the PV module 12, and delivers a corresponding signal to the controller 34. Alternatively, the corresponding voltage may also be measured directly in the controller 34.

Alternatively or additionally, the electronic circuit 20 may comprise a sensor means 44, which is configured to recognize a direction of the current flow. For this purpose, the sensor means 44 may detect, measure, or sense a voltage drop 43₁ and/or 43₂ via at least one of the body diodes 38₁ and/or 38₂. In this regard, the information based on a measurement of only one of the two voltage drops 43₁ or 43₂, or of a subset of the at least two voltage drops of the at least two semiconductor switches, may be sufficient. It should be noted that, in case of using only one switch, a voltage drop is measurable, and in case of a number of more than two switches, also a correspondingly higher number of drops or components of the total voltage drop. Alternatively, the voltage drop 43₁ and 43₂ may be measured individually via each of the at least two serially connected switches, or a total voltage drop may be measured between points 45₁ and 45₂.

The voltage drop 43₁ over the body diode 38₁ and/or the voltage drop 43₂ over the body diode 38₂ may be causally related to the current flow I_{control} along the second current flow direction 28. If, e.g., the voltage drop 43₁ or 43₂ exceeds a predefined threshold value influenced by a respective threshold voltage of the respective body diode 38₁ and/or 38₂, this points to a current flow along the second current flow direction. Analogously, a combinatory threshold value is influenced by the combination of threshold voltages of the serially connected body diodes 38₁ and 38₂ if the measurement takes place via the points 45₁ and 45₂. Even if a detailed evaluation regarding current strength or the like is not excluded, a binary decision in the sense of yes/no may already be sufficient for assessing the presence of the control current I_{control}.

The sensor means 44 may provide a signal 46, which indicates information about the presence of the current flow I_{control}. The information may be present if the signal 46 is provided, or, e.g., if the signal 46 is not provided or provided with a changed property such as amplitude or frequency. Thus, e.g., switching off the signal 46 may contain just as much of information on whether the current I_{control} has started as switching in the signal 46. The current flow information of the controller 34 may be based on the recognized current flow. The signal 46 may, for example, be the detected voltage 43₁ and/or 43₂ itself or a signal derived therefrom.

Even though the sensor means 44 is represented as an element separate from the controller, which element is coupled to the controller 34 at least for transmitting the signal 46 provided by the sensor means 44, the sensor means 44 may also form a part of the controller 34 and be integrated in the same, for example. Thereby, the signal 46 may, for example, be generated internally, or be omitted completely, and/or the controller 34 may detect the voltage drops 43₁ and/or 43₂ directly.

The electronic circuit 20 may optionally comprise further elements. For example, a bypass diode, labeled as D₁, may be coupled between the string terminals 16₁ and 16₂, which bypass diode is configured, in the first state, in which the disconnector 24 disconnects the current path 22, to enable an electric current flow in the string, for example, to enable a current of different serially connected PV modules.

This does not exclude an optional arrangement of at least one resistor element 52 and/or capacitator element 54. Alternatively or additionally, a sensor means 55 for measuring a voltage U_{PV_out} may also be provided.

Optionally, a voltage source 56, labeled as Auxiliary/AUX Supply 56, may also be provided, which is configured to provide, from the voltage U_{PV_in} generated by the PV module 12, for example, 3.3 Volt, or any other value of a supply voltage 58 adapted to the controller 34, in order to operate the controller 34. The electronic circuit may comprise a buffer or energy store, which may provide an energy reserve for supplying the electronic circuit if the PV module provides insufficient amounts of energy.

The electronic circuit 20 and/or the controller 34 may be operated with respect to a reference potential GND, which may be a local reference potential or also an electric ground, in particular in stationary operation. When operating the electronic circuit 20, for example, in a vehicle, the local reference potential GND may be connected, for example, to the body and/or a potential of a vehicle battery. However, different electronic circuits of a string may also comprise reference potentials that are different from one another.

The controller 34 may contain information on whether and/or in what amount a current U_{PV_SM} is provided by the PV module 12 or is conducted to the string. Alternatively or additionally, the controller 34 may obtain information on an amount of the current I_{SM_Bypass} flowing via the bypass diode 48. Alternatively or additionally, the voltage U_{PV_in} applied over the PV module may also be known to the controller 34 and/or the current flow direction may be determined by means of the sensor means 44.

This extent of information allows for a varied control of the electronic circuit 20 in a PV system.

In other words, a possible developed solution described in the embodiments includes an electronic circuit, which comprises as a central element a switch, the disconnector 24 for disconnecting the PV module string. This switch, or these switches, may be brought into circuit, or connected, or switched in a conducting manner or switched off, or switched in a disconnected manner, due to different measurable parameters, so that it can be ensured that, in case of an accident or when the HV circuit is intact, the series connection of the PV modules is disconnected and the voltage in the PV circuit falls below the safety extra-low voltage.

The circuit includes an input, to which a PV module 12 can be connected. A voltage supply, which is fed from the PV module voltage, may be provided, and furthermore, one, two, or more serially connected switches with a disconnection function and a bypass diode may be arranged between input and output. Optionally, one or multiple of the following quantities may be measured: input voltage, output voltage, and PV current, and bypass current. From the measured values, the switch states can be determined by means of a logic in the controller.

In other words, FIG. 2 shows a schematic block circuit diagram of a smart PV module as a circuit for connection and disconnection without communication, i.e. not requiring a communication bus or the like. This does not prevent the transmission of information in a broader sense, such as a stimulus for switching in by means of the current I_{control}. Alternatively or additionally, other states or commands may also be transmitted to the PV module. In order to trigger, e.g., a disconnection on the side of the PV module, the PV module may generate, e.g., a short circuit or an open circuit in the string in order to trigger the desired behavior, disconnection.

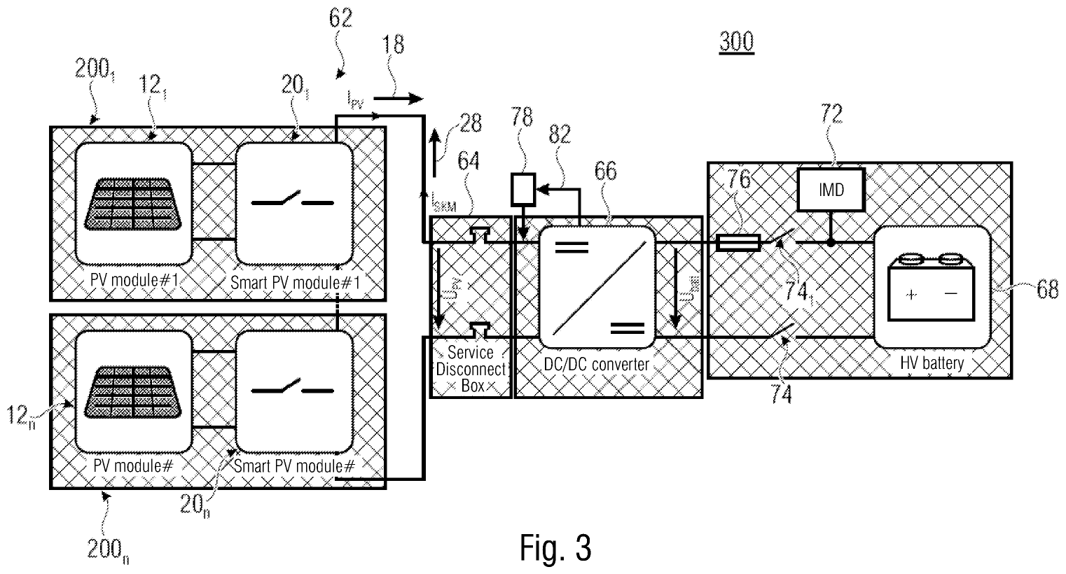

FIG. 3 shows a schematic block circuit diagram of a PV system 300 according to an embodiment. In the PV system 300, a plurality of at least 22, at least 3, at least 5, at least 10 or more PV assemblies may be serially connected to form a string 62. The PV assemblies may be formed, for example in accordance with FIG. 2, wherein a higher number of PV modules may easily be coupled to an electronic circuit, and/or the electronic circuit 10 may be coupled to one or multiple of the PV modules. The electronic circuit 20 of a respective PV assembly 200₁ to 200ₙ with n>1 may disconnect the respective PV module 12₁ to 12ₙ from the string 62. Optionally, the PV system 300 may comprise a so-called Service Disconnect Box 64, meaning a device for disconnecting the PV components or PV assemblies 200 from further components, such as a voltage converter 66, which may exemplarily be embodied as a DC/DC converter, in order to operate a high voltage (HV) battery 68, for example in the case of a mains connection, but may also be operated as a DC/AC converter or a galvanically isolating converter. Alternatively or additionally, an insulation monitoring device 72 may be connected to the battery 68. This does not exclude additional elements such as switches 74₁ and/or 74₂ or resistors/inductances 76.

In the PV system 300, the electric voltage converter 66 may be configured to obtain and convert an electric voltage based on the current flow in the first current flow direction 18, which is labeled, e.g., as U_{PV}. The PV system 300 includes a source 78 for applying the current flow in the second current flow direction 28, for example, on the current I_{control} of FIG. 2. The voltage converter 66 may be configured to control the source 78, for example, by means of a control signal 82, to switch at least one of the PV assemblies 200₁ to 200ₙ into the string 62. In doing so, the current I_{control} may be effective, for example, for all PV assemblies 200₁ to 200ₙ, which, however, leads to a change of the sign of the voltage 43₁ or 43₂ or the voltage between 45₁ and 45₂ only in PV assemblies 200 in the disconnected, first state. In active and connected PV assemblies in the second state, however, no change of state is effected.

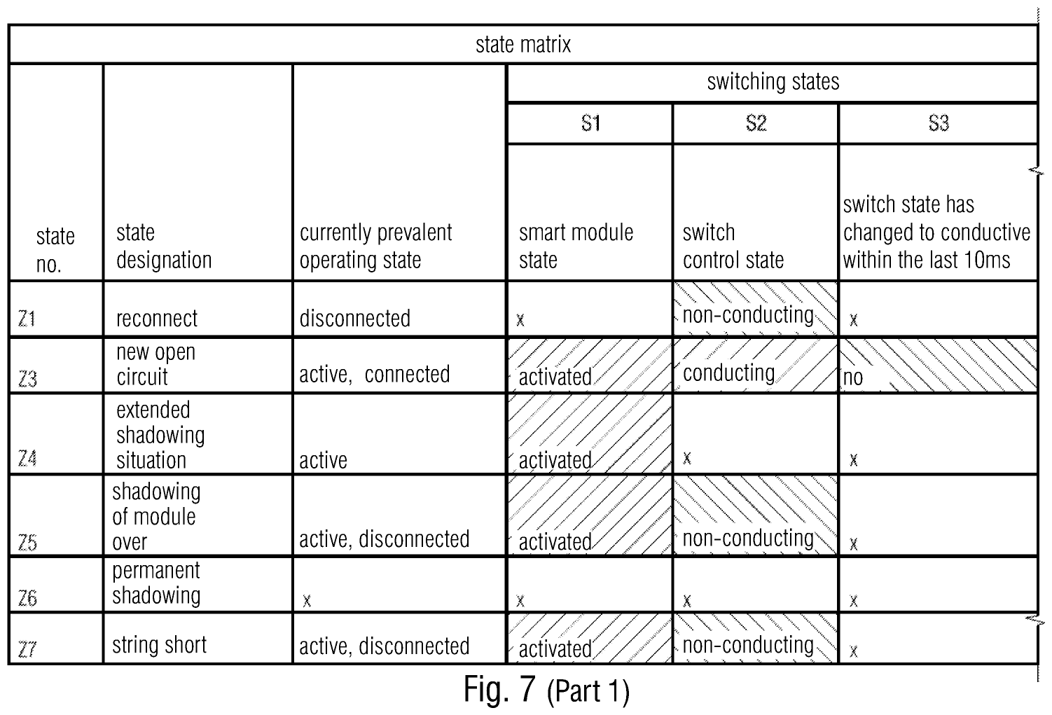

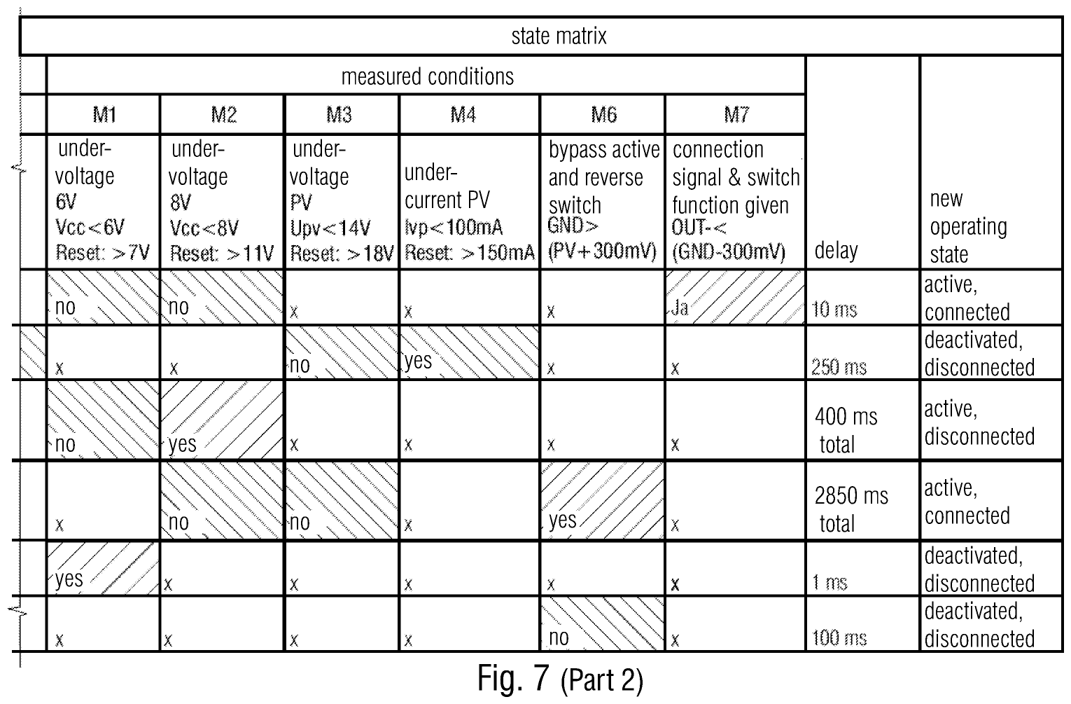

A duration of the current I_{control} along the second current flow direction 28 may be short and be applied, for example, for a period of at least 20 milliseconds and a maximum of 80 milliseconds, at least 10 milliseconds and a maximum of 500 milliseconds, or at least 100 milliseconds and a maximum of 200 milliseconds, wherein shortening the duration may be accompanied by a lower strain on components and power penalties, and a comparatively longer duration may improve the quality of the event transmitted thereby. According to embodiments, the duration is dependent on the design of the logic and is selected, with reference to FIG. 7, for example, so that it is greater than the delay set in state Z1 and/or smaller than the delay set in state Z7.

According to an embodiment, the source 78 is a part of the voltage converter 66 and/or the voltage converter 66 provides a function of the source, meaning that it may be configured to perform a modulation of the voltage U_{PV} or the current I_{PV} or I_{control}.

The current I_{control} may be provided, for example as direct current, for example in order to enable a current flow despite the knowledge of the voltage drop at the body diodes 38₁ and/or 38₂. For example, the source 78 may comprise a current limitation and/or be configured to provide a constant current, which allows for the source 78 to adjust a constant current.

For example, a body diode may effect a voltage drop of about 0.5 Volt, which may be considered accordingly in the interpretations of the voltage converter 66 and/or the source 78.

In other words, FIG. 3 shows a system overview of a vehicle integrated photovoltaic installation with PV modules, smart PV modules 20 according to embodiments, a DC/DC converter, and an HV battery. A smart PV module may be understood to be a PV modules coupled to an intelligent electronic circuit described herein.

In yet other words, an electronic circuit according to embodiments may ensure, in order to avoid the shortcomings of the prior ort, that no voltage that is too high is applied, for example, also while disconnecting the Service Disconnect Box. Electronic circuits described herein make it possible to establish a safe state of the PV modules and the PV circuit by disconnecting the PV circuit. This disconnection takes place close to the PV module and optionally without communication, meaning that an additional signal between the DC/DC converter and the smart PV module, i.e., of the electronic circuit 10 and/or 20 in the form of a message to be transmitted is not necessary. Rather, the parameter voltage and current in the PV module, i.e. input and output, may be observed and, depending on the state, the PV module may be connected or disconnected.

Optionally, further functionalities in the controller or the electronic circuit may be provided in addition to switching in, according to the invention, of the PV module by means of the electronic circuit. In the following, five different state are described in detail for improved understanding:
1. Switching in
2. Maximum Power Point Tracking (MPPT)
3. Switching off caused by a short circuit
4. Switching off caused by an open circuit, for example upon disconnection
or interruption of the string circuit and/or a lack of current flow
5. Switching in after shadowing

### 1. Switching in

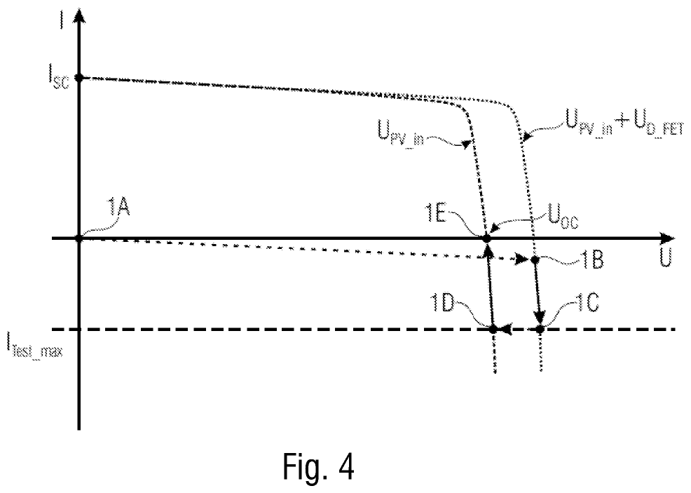

Switching the smart PV module into circuit may be triggered by a voltage source, such as the source 78, for providing a test signal or by the DC/DC converter. The test signal source may be turned on or activated and apply a positive voltage to the output of the smart PV module, wherein reference is made to FIG. 4 for this. Starting from the state represented in point 1A, the voltage may be increased until it corresponds to the sum of the open circuit voltage of the PV module U_{PV_in} in FIG. 2 and the voltage drop over the switches 36₁ and 36₂, represented exemplarily as MOSFETs, which is designated as the parameter U_{D_FET}, in order to reach the state point 1B. This means that the current can be reversed, while the voltage in the string and at the outlets of the circuit remain the same, only the voltage over the non-conducting switches is reversed. The voltage of the test signal is further increased until a test current I_{Test_max} is established, which flows via the body diodes of the switch/switches (MOSFETs) and the PV generator, which is achieved in point 1C. Based on this, the controller may transfer, for example, the disconnector into the second state and switch in the switches S₁ and S₂, which may lead to point 1D. Once all serially connected smart PV modules of the system 300 are brought into circuit, the test signal source is switched off, point 1E, and the PV module transitions into open circuit.

In other words, FIG. 4 shows a U-I graph of the PV module upon being switched in.

### 2. Maximum Power Point Tracking (MPPT)

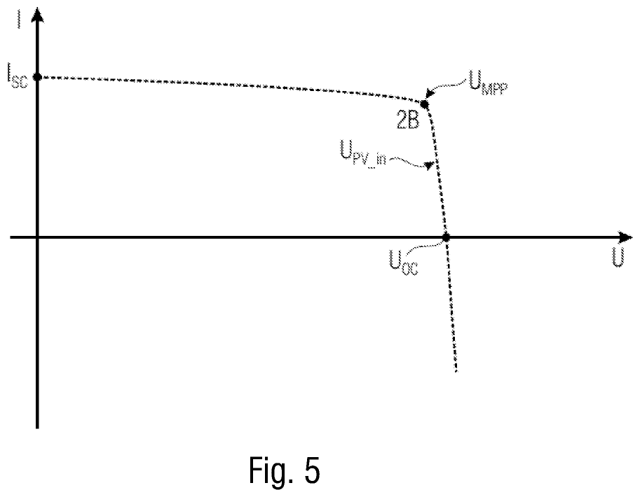

The MPPT is explained with the aid of FIG. 5. If some or all smart PV modules are brought into circuit, the DC/DC converter can become active and operate the entire PV generator in the working point of its maximum power (MPP), cf. point 2B of FIG. 5. For this purpose, an algorithm is used the control of the DC/DC convertor or voltage converter 66, which algorithm searches for said working point by varying the voltage or the current. In order for the smart PV module to remain in this state, it may be provided to maintain a sufficient input voltage U_{PV_in}, see FIG. 2, and to not fall below a threshold value of the PV current I_{PV}_SM.

In other words, FIG. 5 shows a U-I graph of a PV module according to embodiments during an MPP tracking.

### 3. Switching Off Caused by a Short Circuit (SC)

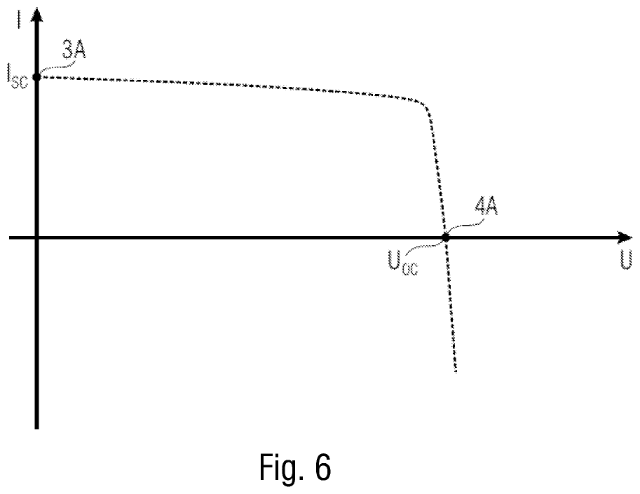

If the output of the smart PV module is short circuited and the PV input voltage decreases for a certain time, such as at least 200 milliseconds, at least 300 milliseconds, or at least 400 milliseconds, e.g. 400 ms, below the exemplary threshold N×U_{SM_Bypass} with N as the number of the serially connected smart PV modules, as shown in point 3A of FIG. 6, the controller may be configured to convert the disconnector into the first state and, for example, to open the switches S₁ and/or S₂. U_{SM_Bypass} refers to the forward voltage of the bypass diode, which may be in the range between 10 mV and 1 V, depending on if it is configured to be active (with a switch and a control) or passive (e.g., Schottky diode). The multiplication is valid for matching values of U_{SM_Bypass} in the different modules.

### 4. Switching Off/Open Circuit (OC)

If the voltage converter is inactive or if there is a cable break, the PV module may go into open circuit as it is shown, for example, in point 4A of FIG. 6. The PV module current falls below a certain threshold. If this state prevails for a certain time, for example when the module current is I_{PV_SM}≤100 mA, and this is the case for a duration of more than 200 milliseconds, more than 300 milliseconds, or more than 400 milliseconds, e.g., about 250 milliseconds, the switches S₁ and/or S₂ may also be disconnected.

In this, the state of a lacking or insufficient current is observed. An interruption of the string is recognizable here. The DC/DC converter may also cause the disconnection via the open circuit by not obtaining a current. In the latter case, the DC/DC converter would apply an open circuit voltage, or the same would establish itself.

In other words, FIG. 6 shows a U-I graph for explaining a switch-off caused by a short circuit and open circuit.

5. Switching in after Shadowing

If a shadowing occurs in a PV module and if the same remains so long that the voltage supply of the smart PV module is no longer ensured, particularly when using the internal voltage source 56, the switch S₁ and/or S₂ may be switched into an opened state, meaning that the disconnector may be brought into the first state. After a predefined time, the switches S₁ and S₂, respectively, are brought into a conductive state if a bypass current has previously flown and a sufficiently high PV input voltage was present, which makes it possible to check whether an end of the shadowing situation exists. Should a shadowing continue to exist, the module will again disconnect caused by a drop of the supply voltage. However, if the shadowing no longer exists, the module remains in the connected state. It may be sufficient to check whether a bypass current flows without measuring how high it is.

FIG. 7 shows an exemplary tabular representation of different states that may be assumed by controllers according to the invention. In particular, it is also represented that a state, which may exist in the controller, may have two stages and be “active or deactivated” in a first stage and “disconnected or connected” in a second stage. Here, the first stage refers to a degree of autonomy of the local module of the PV assembly. In an active state of the same, as it is initially the case, e.g., in states Z3, Z4, Z5, Z6, or Z7, in principle, a local decision may be made on whether a change is made, e.g., from a disconnected state into a connected state, meaning that the disconnector changes into the second state. In an inactive state or deactivated state, as it may be present, e.g., at the start of Z1, the logic of the controller may be configured such that the current flow along the second current flow direction 28 is observable as an event in order to trigger this action. A switching-in via the state Z1 may possibly take place at any point in time, regardless of a previously deactivated state or activated state, as explained by columns S₁, S₂, and S₃ of the table.

In the table, the symbol “x” in a cell means that the state of the switches or the respective condition may be irrelevant. However, the represented times and/or voltages here are to be understood merely as examples and do not limit the present embodiments. Rather, other values may be applied based on the components used.

As can be seen in the table of FIG. 7, the controller may be configured in embodiments to control the disconnector 24 from the second state into the first state based on a switch-off event, which means, for example, opening the switches. With reference to the table of FIG. 7, such switch-off events may be, for example, a new open circuit, a permanent shadowing or a string short circuit. Alternatively or additionally, the controller may be configured to recognize such a switch-off event as a switch-off event caused in the PV module 12, or the string 62, or the electronic circuit 10 or 20, meaning a switch-off event that occurs originating from the voltage converter 66 beyond the Service Disconnect Box 64.

According to an embodiment, the controller may be configured to control the disconnector into the second state, after the recognized switch-off event, depending on the current flow I_{control} along the second current flow direction 28 obtained via the string 62. This means that, according to the embodiment, such a signal or the current flow are possibly needed. Optionally, although this is connected to additional components, an additional communication apparatus may be provided, which transmits a substitute for such a signal, so that the current I_{control} may be triggering for the change into the second state, but in some embodiments constitutes one of many possibilities, whereas, in other embodiments, it constitutes the only possibility. Thus, an electronic circuit may be provided in embodiments, which is configured without a further communication interface, i.e., which may be operated without communication.

According to an embodiment, the controller is configured to temporarily switch the disconnector 24 into the first state upon a temporary power setback of the PV module, for example originating from the state Z4 in FIG. 7 to state Z5, referred to as extended shadowing situation. After a switch-off time, which is, e.g., determined as a predefined time value or is dependent on another event, the disconnector may be controlled into the second state independently of the current flow I_{control} along the second current flow direction 28 obtained via the string 62. The controller is configured to then check whether the temporary power setback has ended. If it is recognized that the end has not yet set in, a change back into the first state is possible. The duration is explained according to an example in FIG. 7, and may amount to about 2,850 ms or a value deviating therefrom. In the table, the initial situation for the state Z4 is described as “active”, meaning that the decision for switching in may be made locally in the controller. Such a switching in that is tentatively initiated in a decentralized manner is possible and is possibly limited to such state for safety reasons, e.g., when a short circuit or an open circuit was recognized previously. In these cases, the controller may be configured to put itself into a deactivated state, in which it may possibly be reactivated and connected by means of the pulse in the second current flow direction and/or optional external reset events.

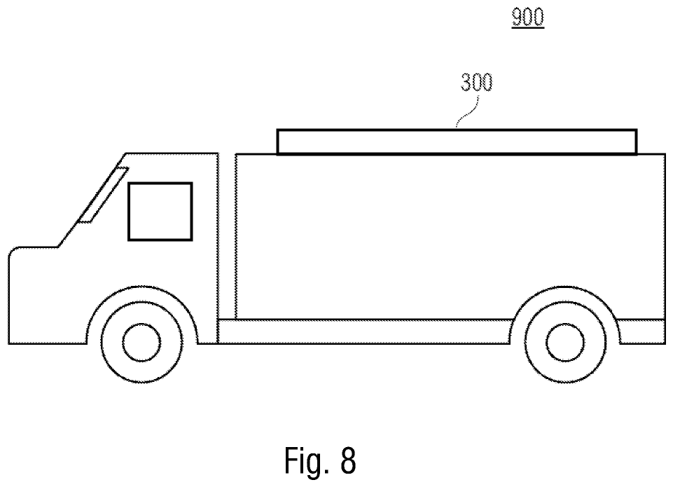

FIG. 8 shows a schematic side sectional representation of a vehicle 900, for example a truck, which includes a PV system according to embodiments described herein, for example the PV system 300. As an alternative to a truck, the vehicle may also be formed in the form of any other vehicle, for example a boat or ship, a motorcycle, a passenger car, or an aircraft, for example a zeppelin, an airplane without or with a motor, a drone, or the like.

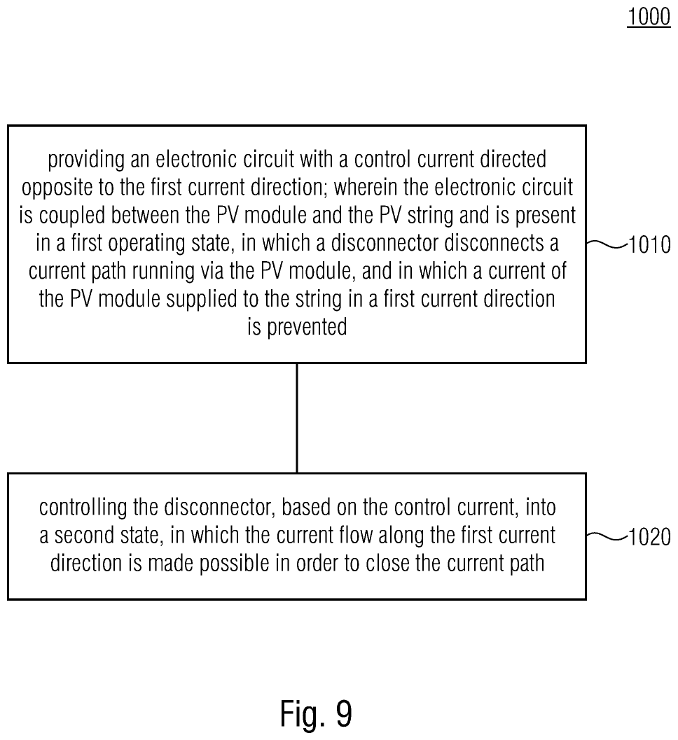

FIG. 9 shows a schematic flow chart of a method 1000 according to an embodiment. The method 1000 may be applied to switch a PV module into a PV string. A step 1010 includes providing an electronic circuit with a control current directed opposite to the first current direction. The electronic circuit is coupled between the PV module and the PV string and is present in a first state, in which a disconnector disconnects a current path running across the PV module, and in which a current of the PV module delivered in a first current direction to the PV string is prevented. A step 1020 includes controlling the disconnector into a second state, in which the current flow along the first current direction is enabled to close the current path based on the control current.

The advantage of embodiments described herein is switching the PV module into circuit and disconnecting it without communication, i.e. without a determined communication channel, in order to achieve a safe voltage of <60 Volt in the PV circuit. The disconnection may be performed by means of one or two or more serially connected MOSFETs. By omitting a communication channel or a communication route, an embodiment may be implemented in a low-cost yet reliable manner. This does not exclude embodiments with an additional communication channel, for example, for different or additional applications.

Embodiments may be used in the area of vehicle integrated photovoltaics. Moreover, this solution may also be used in stationary photovoltaic systems to increase the safety of PV installations relative to known solutions. Where applicable, a safe operation of a high voltage PV system is possible exclusively by disconnecting the series connection of PV modules. The concepts described herein allow for a low-cost solution that can make do without additional communication efforts.

Although some aspects have been described in the context of an apparatus, it is clear that these aspects also represent a description of the corresponding method, so that a block or device is also to be understood as a corresponding method step or a feature of a method step. Analogously, aspects described in the context of or as a method step also represent a description of a corresponding block or detail or feature of a corresponding apparatus.

Depending on certain implementation requirements, embodiments of the invention can be implemented in hardware or in software. The implementation can be performed using a digital storage medium, for example a floppy disk, a DVD, a Blu-Ray disc, a CD, a ROM, a PROM, an EPROM, an EEPROM or a FLASH memory, a hard drive or a different magnetic or optical storage, having electronically readable control signals stored thereon, which are capable of cooperating or cooperate with a programmable computer system such that the respective method is performed. Therefore, the digital storage medium may be computer readable. Some embodiments according to the invention thus comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier.

In other words, an embodiment of the inventive method is, therefore, a computer program having a program code for performing one of the methods described herein, when the computer program runs on a computer. A further embodiment of the inventive methods is, therefore, a data carrier (or a digital storage medium, or a computer-readable medium), on which the computer program for performing one of the methods described herein is recorded.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, in some embodiments, the methods are performed by any hardware apparatus. This may be a universally usable hardware such as a computer processor (CPU) or hardware specific to the method, such as, e.g., an ASIC.

The above-described embodiments are merely illustrative for the principles of the present invention. It is understood that modifications and variations of the arrangements and the details described herein will be apparent to others skilled in the art. It is the intent, therefore, that the invention is limited only by the scope of the patent claims below and not by the specific details presented by way of description and explanation of the embodiments herein.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An electronic circuit for a photovoltaic, PV, module, comprising:
PV terminals for coupling to the PV module; and string terminals for coupling to a PV string;
a current path running between the PV terminals and the string terminals, which current path is configured to conduct an electric current generated in the PV module in a first current flow direction to the PV string;
a disconnector arranged between a first terminal of the PV terminals and a second terminal of the string terminals, which disconnector is configured to interrupt the current path in a first state along the first current flow direction;
and to close the current path in a second state along the first current flow direction;
a controller, which is configured to acquire current flow information about a current flow in at least one sub-portion of the current path along a second current flow direction opposite to the first current flow direction; and to control the disconnector from the first state into the second state based on the current flow information.

2. The electronic circuit according to claim 1, wherein the disconnector is configured to acquire the current flow information from a pulse in the second current flow direction.

3. The electronic circuit according to claim 1, which is configured to acquire a pulse via the string by means of the current flow along the second current flow direction, which pulse indicates the current flow information, in order to change into the second state.

4. The electronic circuit according to claim 1, wherein the disconnector comprises a semiconductor switch with a switchable current path and a diode acting in parallel with the switchable current path, wherein the disconnector is configured to conduct, in the first state of the disconnector, the current flow via the diode along the second current flow direction.

5. The electronic circuit according to claim 1, wherein the disconnector comprises at least a first and a second semiconductor switch, which are connected to one another in series or in parallel, with diodes acting along the second current flow direction.

6. The electronic circuit according to claim 1 comprising a sensor element, which is configured to recognize a current flow along the second current flow direction; wherein the current flow information is based on the recognized current flow.

7. The electronic circuit according to claim 6, wherein the sensor element is configured to detect a voltage drop over a diode, acting in parallel with a switch of the disconnector, of a semiconductor switch of the disconnector, wherein the voltage drop is causally related to the current flow.

8. The electronic circuit according to claim 1 with a bypass diode, which is coupled between the string terminals and is configured to enable, in the first state, an electric current flow in the PV string.

9. The electronic circuit according to claim 1, wherein the controller is configured to control the disconnector from the second state into the first state based on a switch-off event.

10. The electronic circuit according to claim 7, wherein the controller is configured to recognize the switch-off event as a switch-off event caused in the PV module or the string or the electronic circuit.

11. The electronic circuit according to claim 9, wherein the controller is configured to control the disconnector into the second state, after the recognized switch-off event, depending on the current flow along the second current flow direction acquired via the PV string.

12. The electronic circuit according to claim 1, wherein the controller is configured to temporarily switch the disconnector into the first state upon a temporary power setback of the PV module, and to subsequently control it back into the second state independently of the current flow, acquired via the PV string, along the second current flow direction to check whether a temporary power setback causing the switch-off has ended.

13. The electronic circuit according to claim 1, which is configured without a communication interface.

14. The electronic circuit according to claim 1, which is configured to perform, in the second state of the disconnector, at least one of the following functions:
a Maximum Power Point Tracking for the PV module;
disconnecting the PV module from the PV string upon recognition of a short circuit;
disconnecting the PV module from the PV string upon recognition of an open circuit of the PV module;
disconnecting the PV module from the PV string upon recognition of the PV module being shadowed and/or a reconnecting of the PV module to the PV string upon recognition of an end of the shadowing.

15. The electronic circuit according to claim 1, having a sensor element, which is configured to recognize a current flow along the second current flow direction; wherein the current flow information is based on the recognized current flow;
wherein the sensor element is configured to detect a voltage drop over a diode acting in parallel with a switch of the disconnector, wherein the voltage drop is causally related to the current flow;
wherein the controller is configured to temporarily switch the disconnector into the first state upon a temporary power setback of the PV module, and to subsequently control it back into the second state independently of the current flow, acquired via the PV string, along the second current flow direction to check whether a temporary power setback causing the switch-off has ended.

16. A photovoltaic assembly having:
a PV module; and
an electronic circuit coupled to the PV module according to claim 1.

17. A PV system having:
a plurality of PV assemblies according to claim 16, serially connected in a PV string;
an electric voltage converter coupled to the PV string, which is configured to acquire and convert an electric voltage based on the current flow in the first current flow direction; and
a source for applying the current flow in the second current flow direction;
wherein the voltage converter is configured to control the source to switch at least one PV assembly into the PV string.

18. The PV system according to claim 17, wherein the voltage converter comprises the source or is configured to provide a function of the source.

19. The PV system according to claim 17, wherein the source is configured to provide the current along the second current flow direction as a direct current.

20. The PV system according to claim 17, wherein the source comprises a current limitation, and/or is configured to provide a constant current.

21. A vehicle having a PV system according to claim 17.

22. A method for switching a photovoltaic, PV, module into a PV string, comprising:
providing an electronic circuit with a control current directed opposite to the first current direction; wherein the electronic circuit is coupled between the PV module and the PV string and is present in a first state, in which a disconnector disconnects a current path running across the PV module, and in which a current of the PV module delivered in a first current direction to the PV string is prevented;
controlling the disconnector into a second state, in which the current flow along the first current direction is enabled to close the current path based on the control current.
